(19) United States
(12) Patent Application Publication
(10) Pub. No.: US 2025/0005498 A1
(43) Pub. Date: Jan. 2, 2025

(54) MACHINE LEARNING BASED SYSTEM AND METHOD FOR BUDGET MANAGEMENT

(71) Applicant: Insight Systems, Inc., Durham, NC (US)

(72) Inventors: Michael Francis Crooks, Morrisville, NC (US); Shmuel Silverman, Novato, CA (US)

(21) Appl. No.: 18/753,850

(22) Filed: Jun. 25, 2024

Related U.S. Application Data
(60) Provisional application No. 63/510,686, filed on Jun. 28, 2023.

(51) Int. Cl. G06Q 10/067; G06Q 10/0631; G06Q 10/0637

(52) U.S. Cl. CPC G06Q 10/067; G06Q 10/06315; G06Q 10/06375

(57) ABSTRACT

The present disclosure describes a machine learning based system and method for budget management. The system is configured to train and evolve one or more neuroevolutionary models for each project in the budget. The system modulates one or more inputs of the neuroevolutionary model. The system is configured to determine if a received output data from the neuroevolutionary model corresponds to a predicted output. The system is configured to feed the modulated inputs to the neuroevolutionary model if the output data is different from the predicted output and update the neuroevolutionary model. The computing device is configured to use the results of a simulation feedback of the simulation module for budget management. The machine learning system is based on Neuroevolution of Augmenting Topologies (NEAT) to provide efficient budget management.

### CROSS REFERENCE TO RELATED APPLICATION

This application claims the priority benefit of U.S. Provisional Patent Application No. 63/510,686 entitled “Machine Learning based System and Method for Budget Management,” filed Jun. 28, 2023, the contents of which is herein incorporated by reference in its entirety.

### TECHNICAL FIELD

The present disclosure generally relates to budget management, and more particularly, to machine learning based systems and methods for budget management.

### BACKGROUND

Conventional budget formulation and execution are challenging, time-consuming, and inefficient. Such conventional budget formulation often introduces human error and provides no way to simulate potential solutions to impact the set budget strategy. The human process may include setting an unchanging strategy and deciding on actions and activities without any recourse or ability to change the budget or execution of the budget.

Chief Information Officers (CIOs) in the world today are faced with the paradox of accelerating business change while experiencing delays and uncertainty in information collection, integration, and reporting. The CIOs are asked to provide accurate data to answer pressing business questions instantaneously. For example, questions such as how many personnel should be laid off given a financial situation are challenging to address.

### SUMMARY

Conventional budget management techniques do not address the following problems: manual and ad hoc data management of data sources, organizational and/or budget information being sparse or unavailable from a definable source, and unreliable systems security and deployment. Excluding the use of massive contract staff to sift data in spreadsheets of budget data, there is no current technology solution capable of integrating the vast and complex data from procurement, finance, and information technology operations. This conventional approach still results in untimely and inaccurate decisions with respect to budget formulation and execution. Therefore, there is a need for a system and method for budget management that allows an organization to make instantaneous decisions and efficiently support a direct correlation between funds and execution.

The present disclosure describes machine learning (ML) based systems and methods for budget management. The system comprises at least one database and at least one computing device in communication with the database via a network. The computing device comprises one or more memory storing a set of program modules and one or more processors configured to execute the program modules. The modules comprise a simulation module. The simulation module is configured to evolve one or more ML models for each project in the budget to satisfy budget input and achieve desired results. The simulation module is further configured to use the plurality of ML models representing the projects to monitor one or more variations in project results over time with a timely budget and spend input. Deviations in spend by a project relative to planned or forecasted spend may indicate a potential impact on the overall project.

The system modules comprise a budget formulation module, a budget execution module, an asset and service management module and a spend management module. The budget formulation module is configured to receive contracts and subcontracts and generate at least one budget plan for one or more projects. The budget execution module is configured to execute the budget plan. The asset and service management module is configured to receive details related to procured assets and services from the budget execution module on executing the budget plan. The spend management module is in communication with the budget execution module, the budget formulation module, and asset and service management module. The spend management module is configured to receive details related to asset status and service status from the asset and service management module, monitor a real-time execution of the budget plan, and provide updates to the budget plan based on use of funds, or spend plan execution status. The spend management module provides input which is used to update the budget plan and help to determine the impact on a baseline of the budget plan relative to the plan based on determined budget predictions generated by the machine learning models using a baseline version of the budget plan. For example, the spend management module may utilize one or more ML models to determine budget predictions over time using a baseline model of the budget.

The budget formulation module is configured to receive budgeted needs from the budget execution module, and the spend management module is configured to receive budget needs from the budget execution module and the budget formulation module. The spend management module is configured to provide a spend plan to the budget execution module. The modules further comprise a fund management module, a cost management module, a cost recovery module and a contract management module. The fund management module is configured to track the available funds of each project, receive the funding plan from the spend management module, receive cost estimates and funding requests from a cost recovery module, provide fund status to the spend management module and provide fund authorization and fund status to the budget execution module.

The cost management module comprises actual costs from invoices and estimated costs per plan. The cost management module is configured to receive asset status and service status from asset and service module, receive cost priorities and targets from spend management module, receive approved asset and service acquisitions and approved acquisitions strategy from the budget execution module, and provide cost projections to the spend management module.

The cost recovery module is configured to receive the cost recovery plan from the spend management module, receive asset and service usage from the cost management module and ensure budgeted costs are being recovered at a sufficient rate. The contract management module comprises information related to contract to procure and charge for authorized assets and services, the contract management module is configured to receive actual costs and procurement status from the cost management module, and provide contract status to the spend management module to ensure actions related to budget action, funds are valid within a predefined time period.

In this system, an ML model for managing the budget is further described. The ML model is executed by the system comprising at least one database and at least one computing device in communication with the database via a network. The computing device comprises one or more memory storing a set of program modules (e.g., program instructions) and one or more processors configured to execute the program modules (e.g., program instructions) and/or the ML model. At one step, the simulation module is configured to train and evolve one or more of the ML models. Each ML model may represent a project in the budget to satisfy the budget input and achieve the desired results. Each ML model may generate a model representing a project and may be trained given a budget plan as an input and expected state and status as the expected output. The budget plan may be based on a view of a set of projects associated with a budget and in which a particular corporation is executing at any given time. The digital twin represents the set of projects represented by one or more ML models/entities. In some implementations, the digital twin also includes a baseline budget. In some implementations, a baseline budget is provided as an input to the digital twin representing the set of projects rather than the baseline budget being part of the digital twin.

The simulation module is configured to use the ML models representing the projects to monitor one or more variations in project results over time with a timely budget and spend input and project state and status as the output. The simulation module is also configured to use one or more partially unspent resources to improve the overall budget plan and in the process provide a more accurate budget needs predictions and performance predictions which are used to shift the overall budget plan. The simulation module retrain the ML model based subsystem based on the new, improved budget plan. Further, the simulation module may modulate one or more inputs of a neuroevolutionary ML model with the desired effect to improve plan results. These planned results may include a shorter time to product delivery, or different distribution and use of resources.

Although the ML models described herein can be a deep learning model, a neuroevolutionary model may instead be utilized. A pretrained simulated model representing projects may be controlled by modulated inputs to determine how well the results correspond to a predicted output as presented by a budget plan. The computing device is configured to use the results of a simulation feedback of the simulation module for budget management.

In some aspects, the techniques described herein relate to a system for managing a budget. In some aspects, the techniques described herein relate to a system for managing a budget, the system including: at least one database; at least one computing device in networked communication with the at least one database, the at least one computing device including memory storing a set of program modules and one or more processors configured to execute the set of program modules, the set of program modules including a simulation module configured to: receive, for the budget, input for a plurality of projects in the budget; train and evolve one or more machine learning models for each of the plurality of projects in the budget based at least in part on the input, wherein the one or more machine learning models are configured to predict a project state indicating project results; monitor, over a time period and using the one or more machine learning models, the plurality of projects and variations in the project results; determine, based on the monitoring, at least one partially unspent resource associated with the project results monitored over the time period; redirect the at least one partially unspent resource to one or more other projects in the plurality of projects; and retrain the system based on the predicted project state and the redirection of the at least one partially unspent resource.

In some aspects, the techniques described herein relate to a system, wherein the system is a digital twin system. In some aspects, the techniques described herein relate to a system, wherein the set of program modules further include: a budget formulation module configured to receive contracts and subcontracts and generate at least one budget plan for at least one of the plurality of projects, a budget execution module configured to execute the at least one budget plan, an asset and service management module configured to receive details associated with procured assets and services corresponding to executing the budget plan, a spend management module in communication with the budget execution module, the budget formulation module, and the asset and service management module, wherein the spend management module is configured to: receive details related to asset status and service status from the asset and service management module, monitor a real-time execution of the budget plan, and update the budget plan based on determined budget predictions generated by the machine learning models using a baseline version of the budget plan.

In some aspects, the techniques described herein relate to a system, wherein: the budget formulation module is configured to receive budget needs from the budget execution module, and the spend management module is configured to receive budget needs from the budget execution module and the budget formulation module.

In some aspects, the techniques described herein relate to a system, wherein the spend management module is configured to provide a spend plan to the budget execution module. In some aspects, the techniques described herein relate to a system, wherein the set of program modules further include: a fund management module configured to track available funds of each project in the plurality of projects, receive funding plans from the spend management module, receive cost estimates and funding requests from a cost recovery module, provide fund status to the spend management module and provide fund authorization and fund status to the budget execution module.

In some aspects, the techniques described herein relate to a system, wherein the cost recovery module is configured to receive a cost recovery plan from the spend management module, receive asset and service usage from the cost management module and determine whether budgeted costs are being recovered at or above a predefined rate.

In some aspects, the techniques described herein relate to a system, wherein the set of program modules further include: a cost management module including actual costs from invoices and estimated costs per plan, the cost management module being configured to receive asset status and service status from the asset and service management module, receive cost priorities and targets from the spend management module, receive approved asset and service acquisitions and approved acquisitions strategy from the budget execution module, and provide cost projections to the spend management module.

In some aspects, the techniques described herein relate to a system, wherein the set of program modules further include: a contract management module including information related to contracts to procure and charge for authorized assets and services, the contract management module is configured to receive actual costs and procurement status from the cost management module, provide cost projections to the spend management module, and determine whether actions related to the budget are valid within a predefined time period.

In some aspects, the techniques described herein relate to a machine learning based method for managing a budget, the method being executed in a system including at least one database in networked communication with at least one computing device, the at least one computing device including one or more memory storing a set of program modules and one or more processor configured to execute the set of program modules, the method including: training and evolving, at the computing device via a simulation module, one or more machine learning models for one or more projects associated with the budget, wherein the one or more projects is configured to generate project results according to budget input received for the one or more projects; monitoring, at the computing device via the simulation module and the one or more machine learning models, variations in the generated project results over time; determining, based on the monitoring, at least one partially unspent resource associated with the generated project results; redirecting, at the computing device via the simulation module, the at least one partially unspent resource to one or more other projects associated with the budget; and retraining, at the computing device via the simulation module, the system based on the redirection of the at least one partially unspent resource.

In some aspects, the techniques described herein relate to a method, further including: generating, at the computing device via a budget formulation module, at least one budget plan for the one or more projects; executing, at the computing device via a budget execution module, the budget plan, and receiving, at the computing device via an asset and service management module, details associated with procured assets and services corresponding to executing the budget plan.

In some aspects, the techniques described herein relate to a method, further including: receiving, at the computing device via a spend management module, details related to asset status and service status from the asset and service management module; monitoring, at the computing device via the spend management module, a real-time execution of the budget plan, and updating, at the computing device via the spend management module, the budget plan based on determined budget predictions generated by the machine learning models using a baseline version of the budget plan.

In some aspects, the techniques described herein relate to a method, further including: receiving, at the computing device via the budget formulation module, budgeted needs from the budget execution module, receiving, at the computing device via the spend management module, budgeted needs from the budget execution module, and providing, at the computing device via the spend management module, a spend plan to the budget execution module.

In some aspects, the techniques described herein relate to a method, further including: tracking, at the computing device via a fund management module, available funds corresponding to the one or more projects, and receiving, at the computing device via the fund management module, funding plans for the one or more projects from the spend management module.

In some aspects, the techniques described herein relate to a method, further including: receiving, at the computing device via the fund management module, cost estimates and funding requests from a cost recovery module, and providing, at the computing device via the fund management module, fund status to the spend management module, and fund authorization and fund status to the budget execution module.

In some aspects, the techniques described herein relate to a method, further including: receiving, at the computing device via the cost management module, asset status and service status from asset and service module, the cost management module including actual costs from invoices and estimated costs per plan, and receiving, at the computing device via the cost management module, cost priorities and targets from the spend management module.

In some aspects, the techniques described herein relate to a method, further including: receiving, at the computing device via the cost management module, approved asset and service acquisitions and approved acquisitions strategy from the budget execution module, and providing, at the computing device via the cost management module, cost projections to the spend management module.

In some aspects, the techniques described herein relate to a method, further including: receiving, at the computing device via the cost recovery module, a cost recovery plan from the spend management module, and receiving, at the computing device via the cost recovery module, asset and service usage from the cost management module; determining whether budgeted costs are being recovered at or above a predefined rate.

In some aspects, the techniques described herein relate to a method, further including: receiving, at the computing device via a contract management module, actual costs and procurement status from the cost management module, the contract management module including information associated with contracts to procure and charge for authorized assets and services.

In some aspects, the techniques described herein relate to a method, further including: providing, at the computing device via the contract management module, cost projections to the spend management module to determine whether actions associated with the budget are valid within a predefined time period.

The illustrated embodiments are merely examples and are not intended to limit the disclosure. The schematics are drawn to illustrate features and concepts and are not necessarily drawn to scale.

### BRIEF DESCRIPTION OF THE DRAWINGS

FIG. 1 is a block diagram illustrating an example of communication between electronic devices in an example environment.

FIG. 2 is a simplified view of a machine learning based system for budget management.

FIG. 3 is another view the machine learning based system for budget management.

FIG. 4 is a block diagram illustrating an example of genotype-to-phenotype mapping in accordance with an embodiment of the present disclosure.

FIG. 5 is a block diagram illustrating an example of two types of structural mutation in accordance with an embodiment of the present disclosure.

FIG. 6 is a block diagram illustrating an example of matching up genomes for different network topologies using innovation numbers in accordance with an embodiment of the present disclosure.

FIG. 7 is a flow diagram illustrating an example of a method for evolving a NeuroEvolution (NE) object of a user in accordance with an embodiment of the present disclosure.

FIG. 8 is a swimlane diagram of an example model of the system of FIG. 2 for budget management.

FIG. 9 is a block diagram depicting an example component that may use Natural Language Processing (NLP) to facilitate data communication.

FIG. 10 is a flow diagram of an example process using the NLP process to translate human-readable formats into vectors of information to be processed.

FIG. 11 is a block diagram of an example process using a Recurrent Neural Network (RNN) representation of a project or a program.

FIG. 12 is a flow diagram of an example process for training and using an ML model to manage a budget.

FIG. 13 is a flow diagram of an example process of a single step in a search to optimize a budget.

FIG. 14 is a flow diagram of an example process of managing a budget using one or more ML models.

FIG. 15 is an example budget that may be used to train one or more of the ML models described herein.

### DETAILED DESCRIPTION

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

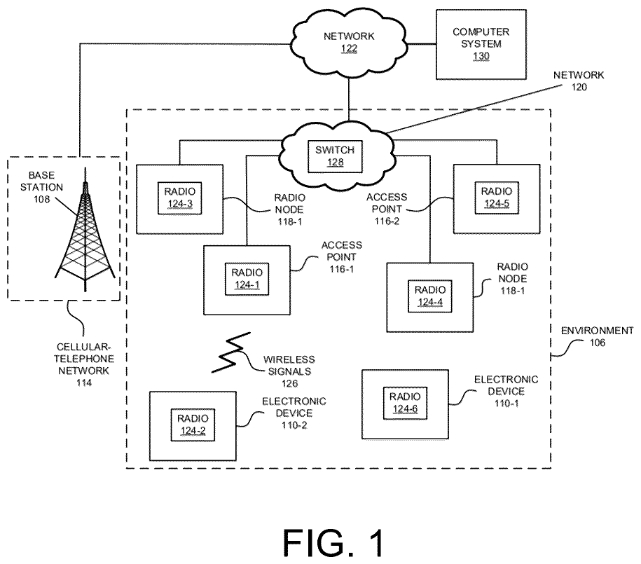

FIG. 1 is a block diagram illustrating an example of communication between electronic devices 110 (such as a cellular telephone, a portable electronic device, a computing device, or another type of electronic device, etc.) in an environment 106. The environment 106 may be used with a number of budget-based techniques of the environments described herein. Moreover, electronic devices 110 may optionally communicate amongst one another and/or with the server computer system 130 via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a communication device. Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely to provide storage and/or analysis services and may be programmed with any one of the ML models described herein) using a wireless or wired communication protocol (such as Ethernet) via network 120 and/or 122. Note that networks 120 and 122 may be the same or different networks. For example, networks 120 and/or 122 may be a LAN, an intranet or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

Electronic devices 110 and/or computer system 130 may implement at least some of the operations in the budgeting techniques described herein As described further below, a given one of electronic devices (such as electronic device 110-1) and/or computer system 130 may perform at least some of the analysis of data associated with electronic device 110-1 (such as first detection of a new peripheral, communication via an interface, a change to software or program instructions, a change to a DLL, a change to stored information, a change to a budget, and/or a change to an machine learning model, etc.) acquired by an agent executing in an environment (such as an operating system) of electronic device 110-1, and may provide data and/or first-detection information to computer system 130.

In some embodiments, the computer system 130 represents a server computing system while electronic devices 110 represent client computing systems. In some embodiments, the computer system 130 represents a client computing system while electronic devices 110 represent server computing systems. Any or all of computer system 130 and electronic devices 110 may be programmed to execute one or more ML models described herein. Further, any or all of computer system 130 and electronic devices 110 may be programmed to execute processes associated with any of the modules described herein.

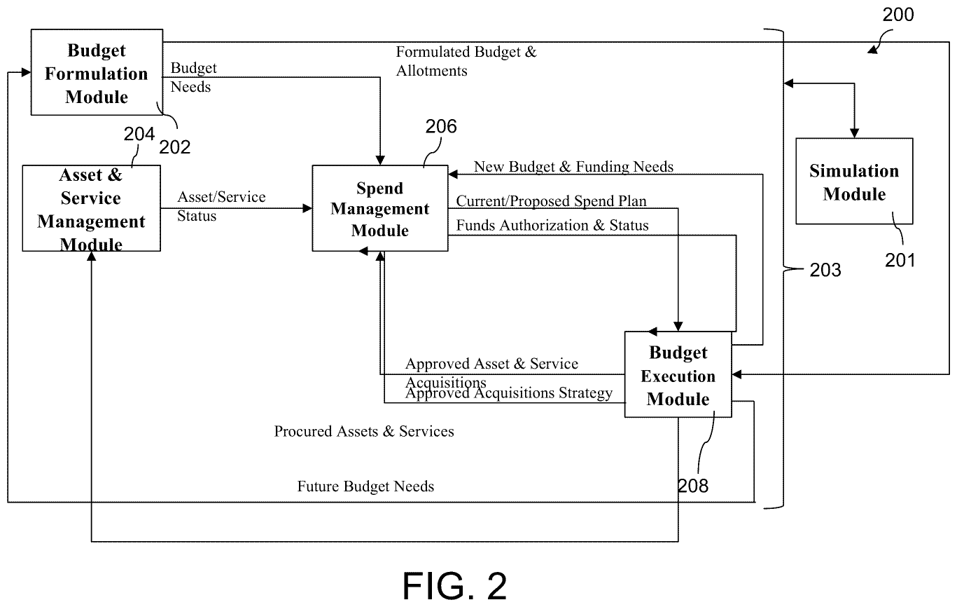

FIG. 2 is a simplified view of a machine learning (ML) based system 200 for budget management. The system 200 may operate as a digital twin system of a budget management system. That is, system 200 may digitally replicate assets associated with a budget management system in a virtual environment. Generating a digital twin system of the budget management system may allow for real-time budget optimization and cost savings by being able to model the budget management system to balance actual spending with planned spending. Furthermore, unlike a predefined budget (e.g., spending plan) set for a fiscal year. the digital twin system 200 may enable realignment and/or optimization of the predefined budget according to actual spending occurring during a fiscal year of operation.

In a conventional budget management system, the processes flow in one direction, from planning to spending. The system 200 may digitally replicate functionality, features, and behavior of the budget management system and as such, can allow the processes to flow in either direction. For example, the digital twin system may include steps that occur between a plan (e.g., a budget spreadsheet) to spend on a contract, for example, and an invoice being paid for that spend. The digital twin system 200 may perform steps to balance the spend by assessing from spend to plan (e.g., backward in the budget) to replan future spend and/or budget planning steps (i.e., redistribute costs (e.g., spend), remove or add other costs, change planning steps and cost amounts, etc.) based on available funds that may pertain to over or under spending with respect to the original planned budget.

In some embodiments, the system 200 may manage a budget of one or more enterprises (e.g., businesses, companies, projects, firms, organizations, etc.). The system 200 may also continuously monitor budget spend execution, and identify and propose improved execution paths to save costs, resources, and time associated with a number of projects (and/or processes defined by the projects) in the budget. The system 200 may represent an ML system that is based on a neuroevolution of augmenting topologies. The system 200 may further include or execute natural language processing to analyze inputs and to automate dynamic creation and automation of an ML model that may execute on a particular budget to assess, plan, and replan expenses/costs when a budget does not match a planned expense/spend.

The system 200 may include at least one database (e.g., memory, data storage associated with devices 110, 130, and/or systems 200, 300) and at least one computing device (e.g., computer system 130) in communication with the database via a network (e.g., network 122). In some embodiments, the computing device may be a server, cloud server, or other remotely accessible computer.

The system 200 may further include a client device (e.g., device 110-1, device 110-2, etc. programmed with any of the ML models described herein). The client device may be a computer or computing device including functionality for communicating (e.g., remotely) over a network. The client device may include one or more processors for executing program instructions. The client device may also include memory for storing the program instructions and data that is used and/or generated by processes being carried out by the client device under the direction of the program instructions described herein. The client device (e.g., device 110-1, device-110-2, etc.) may be a desktop computer, laptop computer, personal digital assistant (PDA), smart phone, table, or mobile device. The client device may execute one or more client applications, such as a web browser, to access and view content over a computer network. The client device may be associated with a user. The database may include information related to projects and budget management of organization.

The network (e.g., network 122) communicates data between the client devices, servers and databases and represents the communication pathways between the server, client device, and any other entities. The network may be the Internet and uses standard communications technologies and/or protocols. Thus, the network can include links using technologies such as Ethernet, worldwide interoperability for microwave access (WiMAX), 3G, long term evolution (LTE), digital subscriber line (DSL), asynchronous transfer mode (ATM), InfiniBand, PCI Express Advanced Switching, etc. Similarly, the networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The system may also use custom and/or dedicated data communications technologies instead of, or in addition to, the ones described above. The computing devices described herein may include one or more memory storing a set of program modules and one or more processors configured to execute the program modules (e.g., having program instructions).

The system 200 includes a number of program modules. The program modules may include a simulation module 201. The simulation module 201 may operate on (or simulate all or a portion of) an environment 203 for managing a budget and predicting an outcome of a proposed budget. System 200 may be digitally replicated to emulate a budget management system in a virtual environment, and as such, the simulation module 201 may simulate changes to budget data, ML model data, and input data to the environment 203 in order to determine an outcome of such changes before implementing such changes in a physical budget (e.g., one or more files, spreadsheets, and related data or computer code that makes up the physical budget).

During an example simulation, the simulation module 201 may train and evolve one or more ML models for each project in a particular budget. In some embodiments, the training and evolving of one or more ML models may occur until a predefined budget input (or other constraint) is satisfied. For example, a predefined budget input associated with an example (physical) budget may include one or more of a list of software and tools licenses used in a project, headcount and job types for the project, software or hardware product used in the project, a specific state of completion (percentage wise) delivered as input from another project or program, and/or an expected current state of this project for each planned product deliverable, or outcome associated with the project.

In some embodiments, the training and evolving of one or more ML models may occur until one or more predefined results are achieved. Predefined results associated with an example budget may include a percentage of completion of project tasks and deliverables associated with the project, as defined as part of the project plan.

The simulation module 201 may also use one or more ML models representing the projects to monitor one or more variations in project results over time and may do so using a predefined and timely budget and/or one or more predefined spend inputs. The simulation module 201 may also use one or more partially unspent resources to improve an overall budget plan by generating recommendations to adjust portions of the budget plan to utilize the one or more partially unspent resources. The simulation module 201 may also retrain the system 200 (e.g., environment 103) based on the improved budget plan. In some implementations, the simulation module 201 may modulate one or more inputs of the neuroevolutionary model of system 200. The simulation module 201 may receive output data for the modulated inputs and determine if the received output corresponds to a predicted output. The simulation module 201 may then feed the modulated inputs into the neuroevolutionary model if the output data is different from the predicted output and may then update the neuroevolutionary model using the output data. A client device (e.g., electronic device 110) may use the results of a simulation feedback of the simulation module 201 for budget management.

The modules further include a budget formulation module 202, an asset and service management module 204, a budget execution module 208 and a spend management module 206. The budget formulation module 202 is configured to receive contracts and subcontracts and generate at least one baseline budget plan for one or more projects. The budget formulation module 202 further may use input including at least financials, human resources, and tools and materials. These inputs may be used in a timeline that is at a known frequency (e.g. weekly, monthly, annually, etc.). This frequency input may be used to train and monitor the performance of the system over time. The budget plan includes a budget for each project for a period of time. The budget plan further includes formulated budget and allotments for each project. The period of time may be on a daily, weekly or monthly basis. The formulated budget and allotments include the budget approved for each project and spend or financial limit allocated to spend on executing the project.

The budget execution module 208 may execute the budget plan. The budget execution module 208 may handle budgets, resources and procurement, and reports the current status including the utilization level of the baseline budget plan. The budget execution module 208 may provide future budget needs to the budget formulation module 202. The future budget needs may include future budget needs and funding requirements defined for each project.

The asset and service management module 204 may provide asset status and service status to the spend management module 206 and receive details related to procured assets and services from the budget execution module 208 for executing the budget plan. The details related to the procured assets and services provides an indication of availability of new assets and services as a result of the budget plan being executed at the budget execution module 208. The asset and service management module 204 may provide the data related to changes in the available assets and services to the enterprises and consumers. The asset and service management module 204 may function as an inventory of assets and services associated with the lifecycle of the budget plan. The asset and service management module 204 may function as an inventory of assets and services with the associated lifecycle and assignment information.

The spend management module 206 in communication with the budget execution module 208, the budget formulation module 202, and asset and service management module 204. The spend management module 206 may monitor a real-time execution of the budget plan, and updates the budget plan. The spend management module 206 receives the budget plan being executed by the budget execution module 208 as input. The spend management module 206 may monitor and modify the directives of the budget execution module 208. The spend management module 206 may also update and optimize the budget plan.

Further, while executing the budget plan, if there are impacts on the baseline budget plan, the budget execution module 208 may send budget needs and funding needs to the spend management module 206. The spend management module 206 updates the budget plan.

In some embodiments, the server device (e.g., computer system 130) may represent the simulation module 201 that functions with each of the other modules described herein (e.g., the budget formulation module 202, the asset and server management module 204, the spend management module 206, the budget execution module 208, the contract management module 210, the cost recovery module 112, the cost management module 214, and/or the fund management module 216). The server device may also be programmed/configured with any one or more of the ML models described herein. In some embodiments, the server device (e.g., computer system 130) may generate and provide program instructions for any or all of the modules described herein. Each module described herein may represent one or more computer programs having executable instructions that may be executed on one processor/computer or on multiple processors/computers at one site, or distributed across multiple sites and interconnected by a communication network (e.g., network 122). Each module may be deployed to be executed on at least one processor to perform functions by operating on input data and generating output. For example, one or more of the modules described herein may function alone or together to carry out the method steps recited herein.

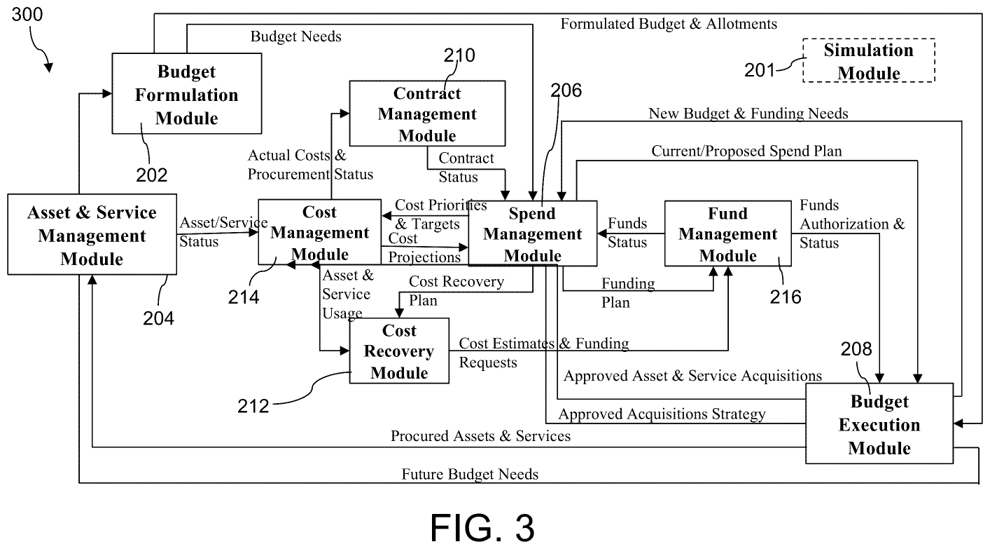

FIG. 3 is another view of the machine learning based system 300 for budget management. The system 300 includes additional modules such as a fund management module 216, a cost recovery module 212, a cost management module 214, and a contract management module 210. In addition, the simulation module 201, budget formulation module 202, asset and service management module 204, spend management module 206, and the budget execution module 208 are also depicted within the system 300.

The contract management module 210 may manage the procurement validation and contract. The contract management module 210 may also provide the contract status to the spend management module 206. The contract management module 210 may maintain key information pertaining to a contract and a contact status. The contract status ensures the actions executed related to the funds for the budget are valid for the corresponding time period. The contract status includes contract information to manage and execute the budget plan. The contract management module 210 may ensure the requisite information to plan, track, and govern the use of approved contracts to procure and/or charge back authorized assets and services for the enterprises are in place and up to date.

The contract management module 210 may also receive data related to actual costs incurred for executing the project and receive procurement status from the cost management module 214. The procurement validation may ensure that the authorized procurements are tracked and reported within the context of the approval ceilings, available funds, and ordered and actual costs. In this example, there may be no inputs/outputs within this subfunction.

The spend budget or spend management module 206 may support creation, baselining, and adjustment of current and future fiscal year spend budgets for the organization. This covers contracted services, anticipated or actual costs, required cost categories, and reporting requirements. The reporting requirements may include OMB Compliance, National Institute of Standards and Technology, Investment Streams, or Technology Business Management. The spend management module 206 may provide cost priorities and targets to the cost management module 214. The spend management module 206 may also provide the funding plan to the fund management module 216. The spend management module 206 may also provide the cost recovery plan to the cost recovery module 212. The spend management module 206 may receive budget needs, new budget and funding needs, funds status, contract status, and cost projections as input. The management module 206 may provide current/proposed spend plan, cost recovery plan, funding plan, and cost priorities and targets as the output of the spend management module 206.

The budget execution module 208 may execute the budget plan using the budgets and resources and controls procurement. The budget execution module 208 may further report the progress of the budget plan being executed to respective modules. The cost recovery module 212 may receive a cost recovery plan from the spend management module 206. The cost recovery plan may include projected costs to be funded by each funding source based on the current spend plans. The cost recovery module 212 may also receive asset and service usage from cost management module 214. The asset and service usage includes information related to accounting of assets and services being provided to the enterprises and its consumers. The cost recovery module 212 may provide cost estimates and funding requests to the fund management module 216. The cost estimates and funding requests includes accounting of each budget cost identifying sufficiency or shortfalls of recovery and the specific stakeholders to initial funds requests. The cost recovery plan and asset and service usage are received as input by the cost recovery module 212 and provides cost estimates and funding requests as output. The cost recovery module 212 may ensure budgeted costs are being recovered at a sufficient rate.

The cost management module 214 includes actual costs from invoices and estimated costs per plan. The cost management module 214 allows for the assembly of requisite information sets for funding the budget resulting in a view of the spend plan for cost control, analysis, and reduction opportunity identification. The cost management module 214 may receive cost priorities and targets from the spend management module 206. The cost priorities and targets are provided based on the enterprise established objectives and spend levels based on current spend plans. The cost management module 214 may receive asset and service status from the asset and service management module 204. The cost management module 214 may also receive approved acquisitions strategy, and approved asset and service acquisitions. The approved acquisitions strategy may include details related to the prioritized supplier categories and offerings. The asset and service status, approved asset and service acquisitions, approved acquisition strategy, and cost priorities and targets are provided as input to the cost management module 214.

The cost management module 214 may provide output data related to actual cost and procurement status, cost projections, and asset and service usage. The cost management module 214 may provide output data related to cost projections to the spend management module 206. The cost projection includes information related to adjustments resulting from cost control, analysis and reduction opportunity identification. The cost management module 214 may provide output data related to actual cost and procurement status to the contract management module 210. The cost management module 214 may provide data related to asset and service usage to the cost recovery module 212.

The fund management module 216 may receive the funding plan from the spend management module 206. The funding plan includes current and anticipated funds. The funding plan includes approved spend levels and funding source for each budget item in the current spend plans. The fund management module 216 may track the available funds of each project, and provide fund status and fund authorization data to the spend management module 206 and the budget execution module 208. The fund management module 216 may provide support to receive and obligate funds to contracts for the planned and/or authorized procurements of services and assets, organizational expenses and other intra-organizational committees. The organizational expenses may include, but are not limited to, salaries, travel, training, and awards.

The cost management module 214 may also manage cost processing, which provides the ad hoc capability to update the actual costs to produce an up-to-date view of the forecasted cost for the given fiscal year. The actual costs may be inputted from invoice importing and entered as a one-time cost. The cost management module 214 may also budget the estimated cost processing, which provides the capability to project the current/actual costs as incurred during the fiscal year for each work effort/procurement anticipated under each contract utilizing the specific spend budget month. If desired, this can be done by supplying the spend plan asset status. The cost management module 214 further includes a service usage processing module. The service usage processing module may provide the capability to update the current/actual usage as incurred during the reporting period for each service provided as or in support of a product offering. The cost management module 214 further includes the asset and service processing module. The asset and service processing module may import and process data sources of the service delivery supply chain in the organization for asset and service consumers and produce a billable inventory of products and/or services.

The cost recovery module 212 may further include a cost model processing module (not shown). The cost management module 214 may create and maintain cost assets to recovery assets to ensure costs have a recovery or offset source. The cost recovery module 212 may further include an assessment module (not shown). The assessment module may calculate, assess, and adjust potential recovery rates based on current or forecasted customer product and service usage, estimated total fiscal costs and current recovery levels by product or service offered. The current recovery levels include chargeback or billed. The cost recovery module 212 may further include a customer impact assessment module (not shown). The customer impact assessment module may create and maintain customer estimates based on actual product and service usage calculated at the projected recovery rates. This helps customers in planning and providing funding to the organization. The cost recovery module 212 may further include a customer statement update module (not shown). The customer statement update module may make financial adjustments to customer funding levels based on unbillable, over billed, or some other material change to estimated cost with respect to provided and/or requested funding. The cost recovery module 212 may further include a recovery processing module (not shown). The recovery processing module may process billable products and services against the formulated recovery rates and pass-through designations to products and publish bill details for customers of the organization.

The fund management module 216 may further include a fund action processing module (not shown). The fund action processing module 216 may align the planned and obligated funding to each work effort anticipated under each contract. The spend management module 206 may further include a budget creation and update module (not shown). The budget creation and update module may create, baseline, and make in-year adjustments in the spend budget. This sub-function allows for the adjustments of the distribution and level of estimated costs, but prohibits the modification of a spend budget once baselined. The spend management module 206 may further include a cost allocation and distribution module (not shown). The cost allocation and distribution module may create and make in-year adjustments in the spend budget cost allocations at the lowest level of cost and ensure the funding sources and reporting categories are assigned as desired. This cost allocation includes, but is not limited to, work activity and software product.

The spend management module 206 may further include a budget overview administration module (not shown). The budget overview administration module may maintain the classification schemes and values for flexibility and alternate reporting needs of stakeholders receiving the spend budget. The spend management module 206 may further include a fund review module (not shown). The fund review module may select or update the desired funding source and/or the Decision Unit (DU) data to produce a specific/alternate view of the spend plan. The spend management module 206 may further include a spend plan processing module (not shown). The spend plan processing module may close the financial reporting month and lock the source data into the audit trail, and to produce the official monthly view of the spend plan.

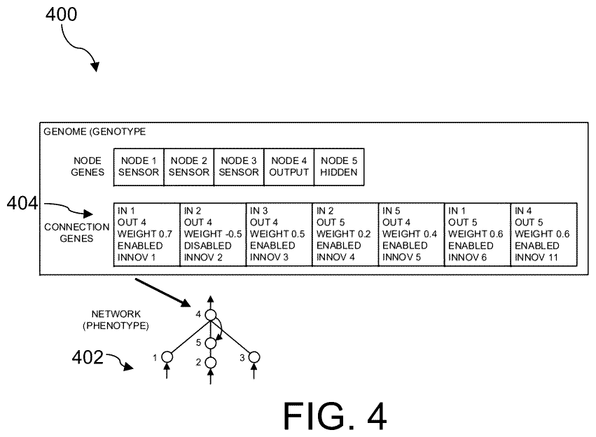

FIG. 4 is a block diagram illustrating an example ML model 400 of genotype-to-phenotype mapping. In some embodiments, the ML model 400 represents a neuroevolutionary model that includes at least one network that may be evolved. In this example, a genotype that produces a phenotype is depicted. In particular, a node tree 402 is shown that represents a series of nodes 1, 2, 3, 4, and 5 and a number of connections between the nodes. The node tree 402 may represent a first iteration before a mutation occurs. The connections represented in node tree 402 (and array 404) may indicate a node in which a connection begins and a node in which the connection ends. In some embodiments, one or more weights associated with a connection may also be included in the array 404. In some embodiments, one or more additional indicators may be included in the array 304.

As shown in FIG. 4, there are three input nodes (1, 2, 3), one hidden node (5), one output node (4), and seven connections defined (1 to 4; 2 to 4; 3 to 4; 2 to 5; 5 to 4; 1 to 5; and 4 to 5), one of which is recurrent (between nodes 4 and 5). Moreover, the second gene (e.g., IN 2) is indicated to be disabled, so the connection that it specifies (between nodes 2 and 4) is not expressed in the phenotype.

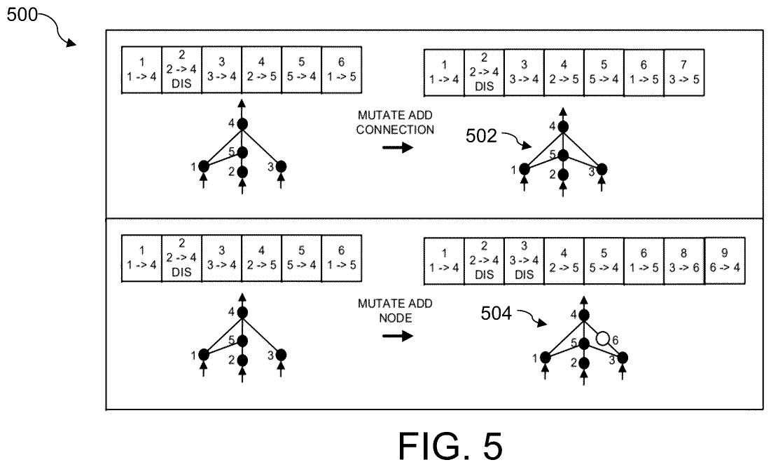

FIG. 5 is a block diagram illustrating an example ML model 500 of two types of structural mutations. In this example, the two types of structural mutations (adding a connection shown by node tree 502 and adding a node shown by node tree 504) are illustrated with the connection genes of a neural network shown above their phenotypes. The top number in each genome represents the innovation number of that gene. The innovation numbers may be historical markers that identify the original historical ancestor of each gene. Moreover, new genes may be assigned new, increasingly larger numbers. When adding a connection, a single new connection gene may be added to the end of the genome and given the next available innovation number. Alternatively, when adding a new node, the connection gene being split may be disabled, and two new connection genes may be added to the end of the genome. The new node may be between the two new connections. A new node gene (not depicted) representing this new node may also be added to the genome.

Utilizing genome-based ML model logic, such as ML models 400 and/or 500, the systems described herein may perform a genetic encoding technique for use with budgets and budget planning. For example, a genetic encoding technique may be designed to allow corresponding genes to be easily aligned when two genomes cross over during mating. As shown in FIG. 4, genomes may be linear representations of neural-network connectivity. A given genome may include a list of connection genes, which each may refer to two node genes being connected. Moreover, node genes may provide a list of inputs, hidden nodes, and outputs that can be connected. Each connection gene may specify the in-node, the out-node, the weight of the connection, whether or not the connection gene is expressed (e.g., an enable bit), and an innovation number, which may allow corresponding genes to be identified or determined. Furthermore, mutation(s) may change connection weights and/or neural-network structures.

In the neuroevolution (NE) techniques, connection weights may mutate, with each connection either perturbed or not at each generation. As shown in FIG. 5, structural mutations may occur in two ways. Each mutation may expand the size of the genome by adding gene(s). In the add connection mutation, a single new connection gene with a random weight may be added connecting two previously unconnected nodes. Alternatively, in the add node mutation, an existing connection may be split and the new node may be placed where the old connection used to be. The old connection may be disabled and two new connections may be added to the genome. The new connection leading into the new node may receive a weight of 1, and the new connection leading out may receive the same weight as the old connection. This method of adding nodes may be used in order to minimize the initial effect of the mutation. Moreover, while the new nonlinearity in the connection may change the function slightly, the new nodes may be integrated into the neural network, as opposed to adding extraneous structure that would have to be evolved into the neural network subsequently. Note that, because of speciation, the neural network may have time to optimize and make use of its new structure.

Furthermore, by using this structure to represent a topology, information in evolution may indicate which genes match up with which counterpart genes between any individuals in a topologically diverse population. This information may indicate the historical origin of each gene. Note that two genes with the same historical origin may represent the same structure (although possibly with different weights), because they were derived from the same ancestral gene at some point in the past. Thus, in order to know which genes line up with which, a network security system may keep track of the historical origin of each gene. Whenever a new gene appears (e.g., through structural mutation), a global innovation number may be incremented and assigned to that gene. Therefore, the innovation numbers may represent a chronology of the appearance of each gene in the network security system. (Consequently, FIG. 4 includes the innovation (INNOV) number.)

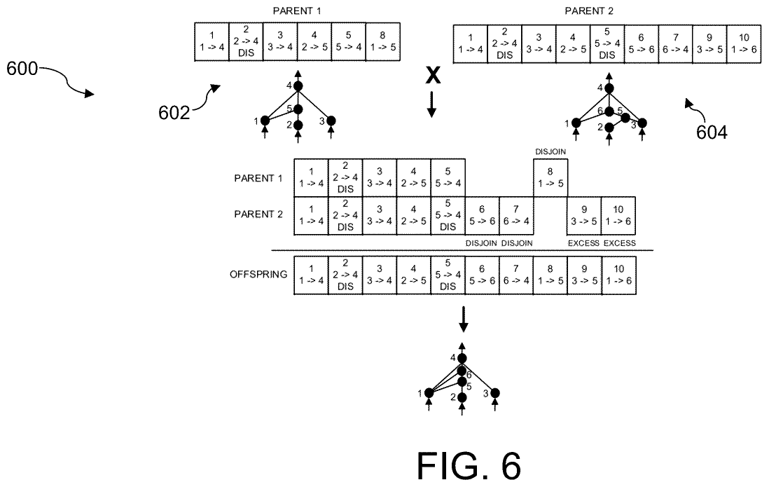

FIG. 6 is a block diagram illustrating an example model 600 of matching up genomes for different network topologies using innovation numbers. Although parent (1) 602 and parent (2) 604 appear to be different, their innovation numbers (shown at the top row of each gene) indicate which genes match up with which. Even without any topological analysis, a new structure that combines the overlapping parts of the two parents, as well as their different parts, may be created. Moreover, matching genes may be inherited randomly, whereas disjoint genes (e.g., those that do not match in the middle) and excess genes (e.g., those that do not match in the end) may be inherited from the more fit parent. In this case, equal fitness may be assumed, so the disjoint and excess genes may also be inherited randomly. Furthermore, the disabled genes may become enabled again in future generations. Thus, there is a preset chance that an inherited gene may be disabled if it is disabled in either parent. By adding new genes to the population and sensibly mating genomes representing different structures, the network security system may form a population of diverse topologies.

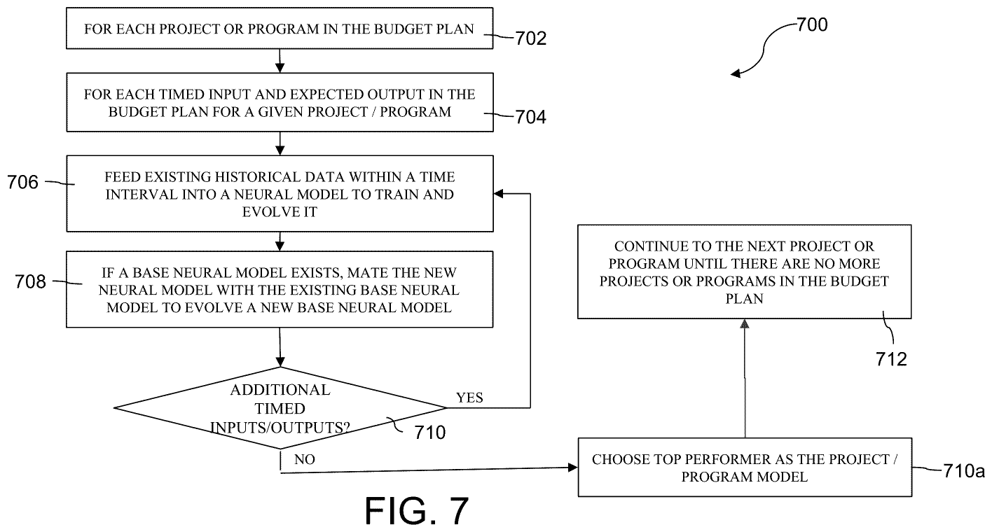

In some embodiments, the systems described herein may develop a neural network (NN) model for each project. Because each project and program resource in a budget is described in detail in a budget plan, a set of inputs and outputs can be defined for the budget based on the details in the budget plan. In order to track and assess data performance over time, there may be an artificial intelligence or machine learning process per project or program. For example, the systems described herein can use the NEAT model to evolve competing populations to achieve the result that for each given input in which there is a given expected output. Once the competing populations produces a champion, this champion may be a NN model that represents the program or project. This artificial intelligence may include an NE object that is initially evolved using existing historical information. This process is further illustrated in FIG. 7, which presents a flow diagram illustrating an example of a method 700 for evolving an NE object of a user using an electronic device in FIG. 1. In short, the process may include, for each project or program in the budget plan (702), and for each timed input and expected output in the budget plan (704), feeding existing historical data within a time interval into an NE neural model to train and evolve it (706). If a base neural model exists, mate the new neural model with the existing base neural model to evolve a new base neural model (708). Repeat feeding exiting historical data of step 706 until there are no more timed inputs/outputs (710), and cycle through each project or program in the budget plan of step 702 until there are no more projects or programs in the budget plan (712).

After this initial phase, a base NE neural model that represents each individual project/program in the budget plan is determined. Speciating the population may allow organisms to compete primarily within their own niches instead of with the population at large. This way, topological innovations may be protected in a new niche where they have time to optimize their structure through competition within the niche. The idea may be to divide the population into species, such that similar topologies are in the same species. This task may involve a topology matching problem. However, once again, historical markings may offer an efficient solution. The number of excess and disjoint genes between a pair of genomes may be a natural measure of their compatibility distance. The more disjoint two genomes are, the less evolutionary history they share, and thus the less compatible they may be with each other. Therefore, the compatibility distance 8 of different structures in the Project or Program population may be determined based at least in part on a linear combination of the number of excess E and disjoint D genes, as well as the average weight differences Ci of matching genes W, including disabled genes: δ=c1·E/N+c2·D/N+c3·W.

Note that the coefficients c1, c2, and c3 may be used to adjust the relative importance of the three factors. Moreover, the factor N, which is the number of genes in the larger genome, may be used to normalize for genome size (N may be set to 1 if both genomes are small, such as fewer than 20 genes). The compatibility distance or distance measure 8 may allow the project/program NE to speciate using a compatibility threshold St. Furthermore, an ordered list of species may be maintained. In each generation, genomes may be sequentially placed into species. Each existing species may be represented by a random genome inside the species from the previous generation. Furthermore, a given genome g in the current generation may be placed in the first species in which genome g is compatible with the representative genome of that species. This way, species may not overlap. If genome g is not compatible with any existing species, a new species may be created with genome g being a representative model.

In embodiments with a centralized model, speciating may be performed by the cloud-based computer system. The neural model may initially be used to evolve a genome that represents an individual operating on a single piece of hardware. Subsequently, assuming the distance between different genomes is not too large, multiple characteristics may be combined as this individual program receives inputs from other programs or new contract types to be executed, thus it operates on multiple pieces of information types or resource types that can vary over time. In some embodiments, a single individual project/program may have multiple genomes that represent their behaviors within multiple disparate situations or modes of behaviors. Moreover, in some embodiments, these genomes may be combined into a single genome that represents this individual project (e.g., program) operating successfully on the combined expected situations and input types. Note that, in either embodiment, the NE model may be unique to the individual program. The following section is about the ability for some programs to be related to others and have similar behavior and performance expectations.

In some embodiments, the speciating model may be used in the evolution of a single individual base NE neural model and this base neural model may also be used to generate speciating across an entire budget plan. When this speciating is employed across the entire budget plan, individual NE objects who share behavior may be allowed to be part of a single species. In general, this capability may allow the population to be monitored on a species basis and to look for anomaly behavior based at least in part on species as opposed to an individual. Therefore, this capability may reduce the performance effort on the system, thus, may allow faster anomaly monitoring in real-time relative to current state and inputs.

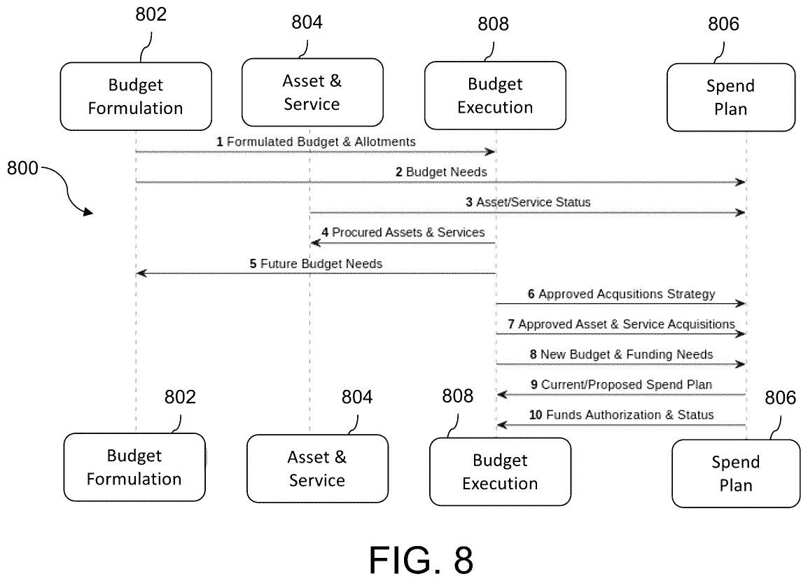

FIG. 8 is a swimlane diagram of an example model 800 of the system of FIG. 2 for budget management. The process between budget formulation, asset and service, budget execution and spend plan are explained with respect to FIG. 2 and FIG. 3. The budget formulation 802 is generated by the budget formulation module 202, asset and service 804 is generated by the asset and service management module 204, budget execution 808 is generated by the budget execution module 208 and spend plan 806 is generated by the spend management module 206. To avoid repetition, the process is not separately explained with respect to FIG. 8 and the description of FIG. 2 and FIG. 3 may be referred to for the explanation of the system of FIG. 8. The contents that are transferred between the budget formulation, asset and service, budget execution and spend plan is encoded into machine-readable coding, such as a language vector that comes from natural language processing tools. The connection between the components of the system to transfer data are represented and performed in numerical order, as shown by numerals 1 to 10 of FIG. 8.

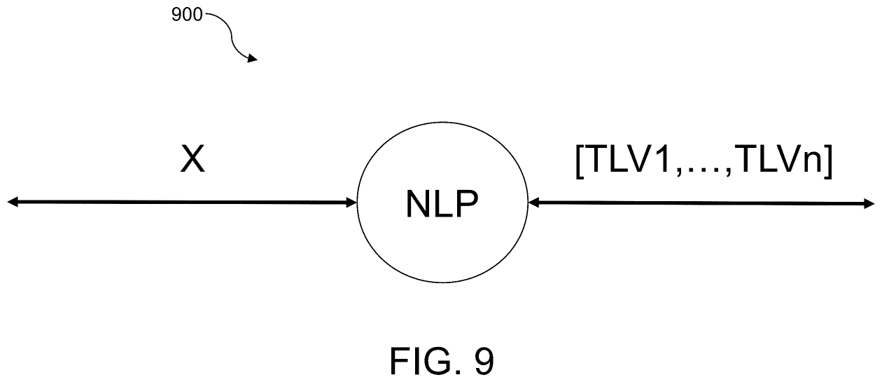

FIG. 9 is a block diagram depicting an example component 900 that may use natural language processing to facilitate data communication of the systems described herein. For example, an input may be received at the system 300. The input to the system 300 could be a textual representation of information that could be any document in a human-readable format, such as a spreadsheet or a document or other formats. The natural language processing component 900 may use the received input to generate a vector of triplets TLV—[Type, Length, Value], i.e., [TLV, . . . TLVn]. Thus, each data flow in FIG. 8 could be represented as a vector of TLV or in a textual human-readable format.

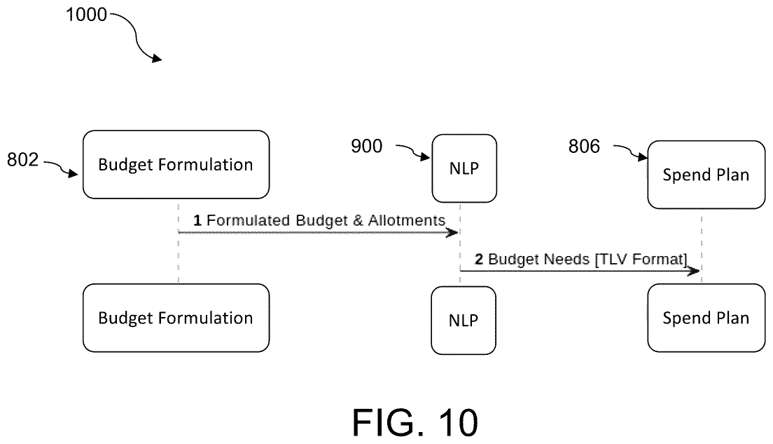

FIG. 10 is a flow diagram of an example process 1000 using an NLP process to translate human-readable formats into TLV vectors of information to be processed by the Spend Plan process performed by the spend management module 206. For example, the process 1000 may be used by computer system 130 and/or electronic devices 110 to generate a digital twin for the organization with a budget formulation 802. The computer system 130 and/or electronic devices 110 may be programmed/configured with one or more of the ML models described herein. The formulated budget and allotments from the budget formulation 802 may be passed through the NLP process 900. The budget needs (in TLV format) may be provided to a spend plan 806. Each project and/or program defined in the budget formulation 802 may be turned into a recurrent neural network (RNN) trained using the NE process and trained to output the current project status and state information. The state information is also recurring as input is provided back into the model 1000.

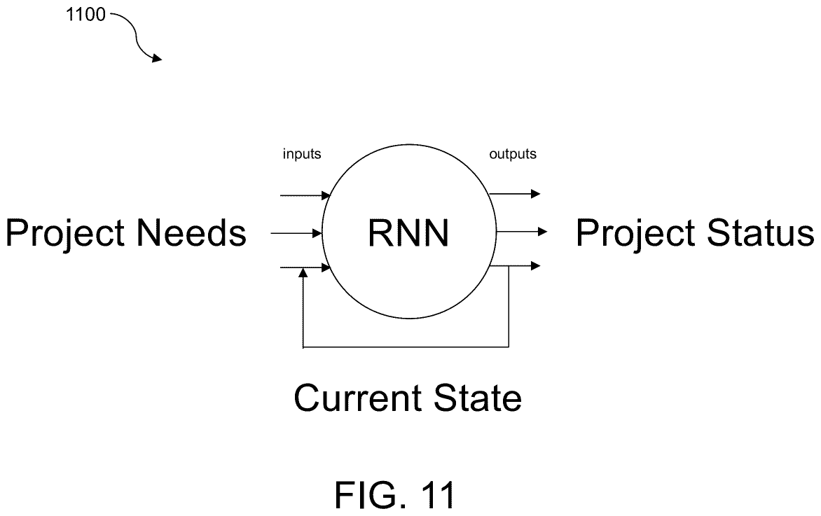

FIG. 11 is a block diagram of an example process 1100 of using an RNN representation of a project or a program. The process 1100 may be used by computer system 130 and/or electronic devices 110 to generate a project status at a particular current project state given particular project needs. The computer system 130 and/or electronic devices 110 may be programmed/configured with one or more of the ML models described herein.

The inputs for the RNN model are included in the spreadsheet received from the budget formulation function. This includes project type, additional resources, and program expected outputs. The inputs and outputs are on a time scale which is captured in the current state information. To generate this RNN, the system uses the NE process, which creates a population of RNNs that compete and evolve to represent this program model and type and also handle deviations from the plan correctly. The system is configured for budget management of one or more enterprises. The system is configured with the ability to move between the enterprises by changing a context without changing the digital twin model of the present invention.

The collection of RNNs (NEs) is a digital representation of the programs and projects in the system. The Spend Plan processes or spend management module 206 uses this representation in real-time to figure out the best path forward if there are deviations from the original plan. For example, earlier in the year the budget distribution is based on the original plan. Thus, in January, for example, each program received the planned budget. Some organizations will report program status and state that reflects the plan and continue to do so until a point where some are late to deliver or to receive the appropriate supply chain or dependent programs. This will result in a lower budget utilization in some and higher needs for an updated budget in others.

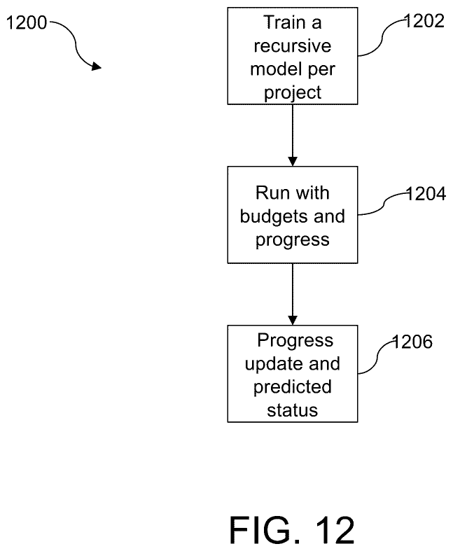

FIG. 12 is a flow diagram of an example process 1200 for training and using an ML model to manage a budget. The process 1200 may be used by computer system 130 and/or electronic devices 110 to train and/or execute an ML model and generate a predicted status for the budget management system. The computer system 130 and/or electronic devices 110 may be programmed/configured with one or more of the ML models described herein.

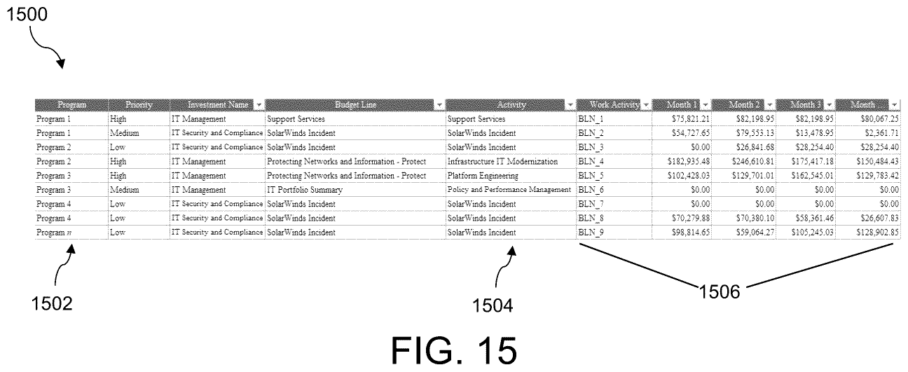

At step 1202, the system (e.g., computer system 130 programmed/configured with one or more ML models described herein) may train an RNN for each project within a budget. The training models may be based on existing and previous budget plans used by the organization including budget performance and budget changes over time. Each program (e.g., project) and type of program may be generated and/or presented by an ML model. Each ML model may be evolved until the respective ML model can predict performance based on budget input over time within a margin of error to the annotated results. In FIG. 15, an example of a set of budget line items that are input to a program, identifying the activity 1504 and respective month 1506. Each activity in the budget, e.g. each row in the budget plan is traced via a unique activity code to the project plan associated with this program. The project plan may be used to determine an understanding of percent completion of the program or percent delay. Using this annotated input, one skilled in the art can train and evolve a ML model to receive budget plan versus budget spent to predict current percent completion.

At step 1204, the budget and details about the budget may be provided as input. Further, the system (e.g., system 200, system 300, etc.) may expect specific status data and specific new state data according to the budget plan. The change in the budget planning captures resources and allows for a new and/or improved budget plan to maximize the overall budget utilization. Step 1204 may be repeated for each cycle. For example the inputs may include, but are not limited to, funding, resources, and dependencies for one or more projects. The dependencies may represent requirements for other projects or programs to be in a specific state of completion and able to deliver inputs into this project or program. The expected or anticipated status and state of a program or a project includes at least the percent completion for each task and deliverable in the program.

At step 1206, current cycle information is fed to the RNN and the process 1200 measures the deviation from what is the expected status and state in the current cycle based on the simulation. In this way, the process 1200 may optimize underuse and/or balance overuse of a budget in real time rather than generate predictions of how a budget may be changed. If the process 1200 determines an underuse of a budget, the process 1200 may find one or more projects or spend events that may instead use the additional budget available based on the underuse in the original project or spend event in which the budget was slated. The system 1200 may reprioritize and otherwise manage the budget and/or resources associated with the budget in real time to maximize outcomes of budget usage.

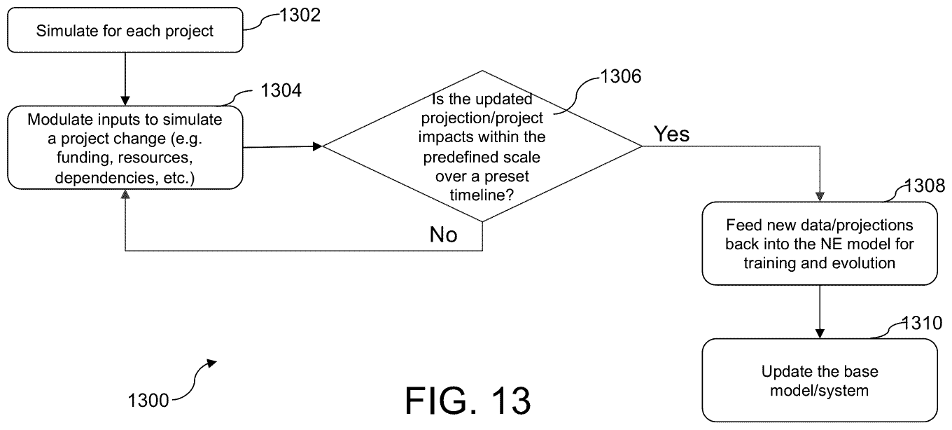

FIG. 13 is a flow diagram of an example process 1300 of a single step in the search to optimize a budget. The process 1300 may be used by computer system 130 and/or electronic devices 110 to update a base model/budget according to projections/predictions generated by the ML models described herein. The computer system 130 and/or electronic devices 110 may be programmed with one or more of the ML models described herein.

For each project that is impacted in a current cycle, e.g., demonstrated deviations from planned status and state, the process 1300 may modify the budget and measure results over multiple cycles until the system finds a path to catch up to the predefined budget plan or to get a minimal deviation from the predefined budget plan within a given period of time. The process 1300 may be applied for each project in the budget.

At step 1302, the process 1300 may be executed for each project in the budget. The system (e.g., system 200, system 300, etc.) may train one or more neuroevolutionary models for each project in a budget. At step 1304, one or more inputs to the neuroevolutionary model may be modulated. The one or more inputs may include, but are not limited to, funding, resources, and dependencies. At step 1306, the system may check if the update inputs impact the baseline budget within a predefined scale such as percentage deviation from a preset timeline, e.g., within each fiscal year for any deviation less than 3%; between 3% and 7%; and over 7% of year-to-date cost over or under the month-over-month baseline budget and expected completion or progress state. At step 1308, if the new inputs impact the baseline budget, the new data and projects are fed into the neuroevolutionary model for training and evolution. At step 1310, the base system is also updated.

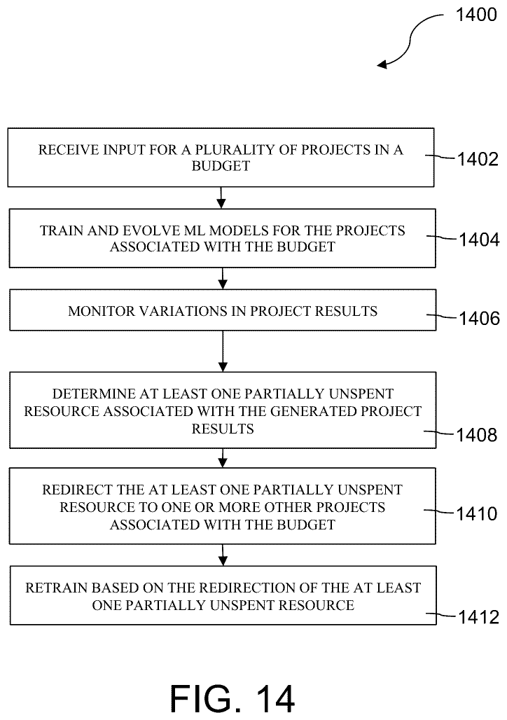

FIG. 14 is a flow diagram of an example process 1400 of managing a budget using one or more ML models. For example, the process 1400 may represent a machine learning based method for managing a budget. In some implementations, the process 1400 may be executed on a server system, such as computer system 130 configured with one or more ML models described herein. In some implementations, the process 1400 may instead be performed locally by one or more client devices, such as electronic devices 110 configured with one or more ML models described herein. In either case, the process 1400 may be executed using a digital twin of the budget. For example, the process 1400 may digitally replicate assets associated with a budget management system in a virtual environment where the system is a digital twin of the budget management system.

The system utilized to carry out process 1400 may include one or more computing systems (e.g., device 130 and/or one or more electronic devices 110). The system may include at least one database (e.g., memory, data storage associated with devices 110, 130, and/or systems 200, 300) that is in networked communication with at least one computing device (e.g., devices 110-1, 110-2, etc.). The at least one computing device may include one or more memory storing a set of program modules and one or more processor programmed to execute the set of program modules (e.g. modules 201-216).

At step 1402, the process 1400 includes receiving, for a budget, input for a plurality of projects in the budget (plan). For example, the server computing device 130 may receive input including, but not limited to, funding data about the budget, resource data pertaining to the budget and/or the funding data, and dependency data indicating time based dependencies between respective resources and the respective funding associated with each particular project in the plurality of projects. In one non-limiting example, the process 1400 may receive details related to asset status and service status from the asset and service management module 204.

At step 1404, the process 1400 includes training and evolving, at the computing device via a simulation module, one or more ML models for each of the plurality of projects associated with the budget. For example, the server computing device 130 may execute the simulation module 201 to train and evolve one or more ML models for a particular project associated with the budget. The training and evolving may be based at least in part on the received input. The one or more ML models may be configured to predict a project state for each project in the budget. The project state for each project may be associated with particular project results. For example, the project state and project results may be updated over time. The ML models may utilize one or more of the updates (e.g., changes) in the projects or in the input to the projects in order to simulate project progression and predict a project state and particular project results achieved at the predicted project state. Training and evolving are described in detail with respect to process 1200 and process 1300 above.

At step 1406, the process 1400 includes monitoring variations in the project results over time. For example, the process 1400 may monitor a real-time execution of the budget plan to determine variations in project results over time. The monitoring can be performed by the server computing device 130 via the simulation module 201 using any one or more ML models described herein. The act of monitoring in step 1406 involves executing the representative model for each project and program providing it with current spent/used budget and reviewing the output results, e.g. the state of each task in this program.

At step 1408, the process 1400 includes determining, based on the monitoring, at least one partially unspent resource associated with the project results. For example, if the current project completion state is on target, the partial use of the budget did not impact it negatively and the process 1400 can free this budget for use in other projects or programs that are running late. When the unused budget changes the current completion state, the process 1400 determines and provides the delta resources to a later cycle in the project using the simulation.

At step 1410, the process 1400 includes redirecting the at least one partially unspent resource to one or more other projects associated with the budget. The redirection may be performed by the server computing device 130 via the simulation module 201. An example of redirecting unspent resources may include headcount that was not available in time for a specific program, yet the program was able to deliver on its plan state. These resources can be assigned to a different program in order to help that program to improve delivery time or catch up to the planned program state when it is being delayed. In one non-limiting example, the process 1400 may include updating the budget (plan) based on determined budget predictions generated by the ML models using a baseline version of the budget (plan).

At step 1412, the process 1400 includes retraining the system based on the predicted project state and the redirection of at least one partially unspent resource. For example, when an unspent budget resource is redirected to a delayed program that could benefit from more resources, the system 300 may retrain program ML model representative to reflect the change in budget input while maintaining the new expected outcomes for this program.

In some implementations, the process 1400 may also utilize the budget formulation module 202 to receive contracts and subcontracts and generate at least one budget plan for at least one of the plurality of projects. The process 1400 may also utilize the budget execution module 208 to execute the at least one budget plan. The process 1400 may further utilize the asset and service management module 204 to receive details associated with procured assets and services corresponding to executing the budget plan. The process 1400 may further utilize the spend management module 206 in communication with the budget execution module 208, the budget formulation module 202, and the asset and service management module 204, where the spend management module 206 may receive details related to asset status and service status from the asset and service management module 204, monitor a real-time execution of the budget plan, and update the budget plan based on determined budget predictions generated by the machine learning models described elsewhere herein using a baseline version of the budget plan.

In some implementations, the process 1400 may utilize the fund management module 216 to track available funds of each project in the plurality of projects, receive funding plans from the spend management module 206, receive cost estimates and funding requests from the cost recovery module 212, provide fund status to the spend management module 206, and provide fund authorization and fund status to the budget execution module 208. The cost recovery module 212 may receive a cost recovery plan from the spend management module 206, receive asset and service usage from the cost management module 214, and determine whether budgeted costs are being recovered at or above a predefined rate based on the received cost recovery plan and/or received asset and service usage.

In some implementations, the process 1400 may utilize the cost management module 214 that includes actual costs from invoices and estimated costs per plan where the cost management module 214 may receive asset status and service status from the asset and service management module 204, receive cost priorities and targets from the spend management module 206, receive approved asset and service acquisitions and approved acquisitions strategy from the budget execution module 208, and provide cost projections to the spend management module 206 based on such received data.

In some implementations, the process 1400 may utilize the contract management module 210 that includes information related to contracts to procure and charge for authorized assets and services where the contract management module 210 may receive actual costs and procurement status from the cost management module 214, provide cost projections to the spend management module 206, and determine whether actions related to the budget are valid within a predefined time period based on such received data. Advantageously, the present disclosure describes the use of machine learning to automate and solve the real-time challenges of planning, forecasting, reporting, and analytics of spending plans and budget strategies while adhering to the overall goal of the organization. The system enables users to make faster and more informed decisions, ultimately creating real-time and timely value for the business. The system supports evolutionary, unsupervised, and curious models to improve recommendation quality and find the best strategy course correction to the current state of the real world. The system may support decisions for sustainable improvement of companies while adhering to full compliance. The system may also control processes in companies and organizations of various sizes in full compliance. The system may utilize a neuroevolution model and a digital twin system of a budget management system. For example, a budget plan may be based on a view of a set of projects that a particular corporation is executing at any given time. The digital twin represents the set of projects represented by one or more ML entities. The system may also continuously monitor budget spend execution, and identify and propose improved execution paths. The system may utilize and include a core machine learning (ML) system that is based on the neuroevolution of augmenting topologies to allow for the exploration of more efficient budget spending solutions. The system may further employ natural language processing to understand/analyze inputs and simply automate dynamic creation and automation of the ML model.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

FIG. 15 is an example budget 1500 that may be used to train one or more of the ML models described herein. The budget plan 1500 includes a number of programs (e.g., projects). In this example, the programs are listed in rows. However, any layout of a set of programs may be used by the ML models described herein. In general, each program may be associated with any number of activities, subactivities, or the like. The ML models described herein may correlate between a row entry and a related project plan activity entry. In addition, a budget row may be correlated to multiple subactivities in the project plan nestled under a work activity identifier, which may further be correlated by the ML models to particular row entries (e.g., programs/projects). The systems described herein may use data generated by the correlation to train the ML (evolution) models described herein and to predict a percent completion or delay in programs based on changes in predicted spending or outlaid spending captured in the budget plan. In the training project or the evolution process, the systems described herein may use the project plan information to associate project progression with budget spending over time. Variations may be allowed in results within some predefined delta error. Upon generating a trained model, the systems described herein may predict delays in programs/projects based on changes in budget, which can be reflected by delayed spending, for example.

What is claimed is:

1. A system for managing a budget, the system comprising:
at least one database;
at least one computing device in networked communication with the at least one database, the at least one computing device comprising memory storing a set of program modules and one or more processors configured to execute the set of program modules, the set of program modules comprising a simulation module configured to:
receive, for the budget, input for a plurality of projects in the budget;
train and evolve one or more machine learning models for each of the plurality of projects in the budget based at least in part on the input, wherein the one or more machine learning models are configured to predict a project state indicating project results;
monitor, over a time period and using the one or more machine learning models, the plurality of projects and variations in the project results;
determine, based on the monitoring, at least one partially unspent resource associated with the project results monitored over the time period;
redirect the at least one partially unspent resource to one or more other projects in the plurality of projects; and
retrain the system based on the predicted project state and the redirection of the at least one partially unspent resource.

2. The system of claim 1, wherein the system is a digital twin system.

3. The system of claim 1, wherein the set of program modules further comprise:
a budget formulation module configured to receive contracts and subcontracts and generate at least one budget plan for at least one of the plurality of projects,
a budget execution module configured to execute the at least one budget plan,
an asset and service management module configured to receive details associated with procured assets and services corresponding to executing the budget plan,
a spend management module in communication with the budget execution module, the budget formulation module, and the asset and service management module, wherein the spend management module is configured to:
receive details related to asset status and service status from the asset and service management module,
monitor a real-time execution of the budget plan, and
update the budget plan based on determined budget predictions generated by the machine learning models using a baseline version of the budget plan.

4. The system of claim 3, wherein:
the budget formulation module is configured to receive budget needs from the budget execution module, and
the spend management module is configured to receive budget needs from the budget execution module and the budget formulation module.

5. The system of claim 3, wherein the spend management module is configured to provide a spend plan to the budget execution module.

6. The system of claim 3, wherein the set of program modules further comprise:
a fund management module configured to track available funds of each project in the plurality of projects, receive funding plans from the spend management module, receive cost estimates and funding requests from a cost recovery module, provide fund status to the spend management module and provide fund authorization and fund status to the budget execution module.

7. The system of claim 6, wherein the cost recovery module is configured to receive a cost recovery plan from the spend management module, receive asset and service usage from the cost management module and determine whether budgeted costs are being recovered at or above a predefined rate.

8. The system of claim 3, wherein the set of program modules further comprise:
a cost management module comprising actual costs from invoices and estimated costs per plan, the cost management module being configured to receive asset status and service status from the asset and service management module, receive cost priorities and targets from the spend management module, receive approved asset and service acquisitions and approved acquisitions strategy from the budget execution module, and provide cost projections to the spend management module.

9. The system of claim 3, wherein the set of program modules further comprise:
a contract management module comprising information related to contracts to procure and charge for authorized assets and services, the contract management module is configured to receive actual costs and procurement status from the cost management module, provide cost projections to the spend management module, and determine whether actions related to the budget are valid within a predefined time period.

10. A machine learning based method for managing a budget, the method being executed in a system comprising at least one database in networked communication with at least one computing device, the at least one computing device comprising one or more memory storing a set of program modules and one or more processor configured to execute the set of program modules, the method comprising:
training and evolving, at the computing device via a simulation module, one or more machine learning models for one or more projects associated with the budget, wherein the one or more projects is configured to generate project results according to budget input received for the one or more projects;
monitoring, at the computing device via the simulation module and the one or more machine learning models, variations in the generated project results over time;
determining, based on the monitoring, at least one partially unspent resource associated with the generated project results;
redirecting, at the computing device via the simulation module, the at least one partially unspent resource to one or more other projects associated with the budget; and
retraining, at the computing device via the simulation module, the system based on the redirection of the at least one partially unspent resource.

11. The method of claim 10, further comprising:
generating, at the computing device via a budget formulation module, at least one budget plan for the one or more projects;
executing, at the computing device via a budget execution module, the budget plan, and
receiving, at the computing device via an asset and service management module, details associated with procured assets and services corresponding to executing the budget plan.

12. The method of claim 11, further comprising:
receiving, at the computing device via a spend management module, details related to asset status and service status from the asset and service management module;
monitoring, at the computing device via the spend management module, a real- time execution of the budget plan, and
updating, at the computing device via the spend management module, the budget plan based on determined budget predictions generated by the machine learning models using a baseline version of the budget plan.

13. The method of claim 12, further comprising:
receiving, at the computing device via the budget formulation module, budgeted needs from the budget execution module,
receiving, at the computing device via the spend management module, budgeted needs from the budget execution module, and
providing, at the computing device via the spend management module, a spend plan to the budget execution module.

14. The method of claim 12, further comprising:
tracking, at the computing device via a fund management module, available funds corresponding to the one or more projects, and
receiving, at the computing device via the fund management module, funding plans for the one or more projects from the spend management module.

15. The method of claim 14, further comprising:
receiving, at the computing device via the fund management module, cost estimates and funding requests from a cost recovery module, and
providing, at the computing device via the fund management module, fund status to the spend management module, and fund authorization and fund status to the budget execution module.

16. The method of claim 15, further comprising:
receiving, at the computing device via the cost management module, asset status and service status from asset and service module, the cost management module comprising actual costs from invoices and estimated costs per plan, and
receiving, at the computing device via the cost management module, cost priorities and targets from the spend management module.

17. The method of claim 16, further comprising:
receiving, at the computing device via the cost management module, approved asset and service acquisitions and approved acquisitions strategy from the budget execution module, and
providing, at the computing device via the cost management module, cost projections to the spend management module.

18. The method of claim 17, further comprising:
receiving, at the computing device via the cost recovery module, a cost recovery plan from the spend management module, and
receiving, at the computing device via the cost recovery module, asset and service usage from the cost management module;
determining whether budgeted costs are being recovered at or above a predefined rate.

19. The method of claim 18, further comprising:
receiving, at the computing device via a contract management module, actual costs and procurement status from the cost management module, the contract management module comprising information associated with contracts to procure and charge for authorized assets and services.

20. The method of claim 19, further comprising:
providing, at the computing device via the contract management module, cost projections to the spend management module to determine whether actions associated with the budget are valid within a predefined time period.
